(19) United States
(12) Patent Application Publication
(10) Pub. No.: US 2006/0067683 A1
(43) Pub. Date: Mar. 30, 2006

(54) Photo-finishing apparatus for silver halide photosensitive material and control method of processing solution for silver halide photosensitive material

(75) Inventors: Hiroshi Yamashita, Tokyo (JP); Shinji Kadota, Tokyo (JP); Hiroaki Kobayashi, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/226,638

(22) Filed: Sep. 14, 2005

(30) Foreign Application Priority Data
Sep. 30, 2004 (JP) JP2004-286705

(51) Int. Cl. G03D 3/02

(52) U.S. Cl. 396/626

(57) ABSTRACT

A photo-finishing apparatus for a silver halide photosensitive material, including an agitating device to agitate or circulate a processing solution in a processing tank, a time detecting device to detect an elapsed time since a processing operation was completed, a temperature detecting device to detect temperature of the processing solution in the processing tank, and a control section to control operation of the agitating device by such ways that when the time detecting device detects a predetermined elapsed time, the control section deactivates the agitating device, and when the temperature detecting device detects that the temperature of the processing solution in the processing tank has dropped lower than a predetermined lower limit temperature, the control section re-activates the agitating device, and continues to activate until the temperature detecting device detects that the temperature of the processing solution in the processing tank has increased to a predetermined acceptable processing temperature.

This application is based on Japanese Patent Application No. 2004-286705 filed on Sep. 30, 2004, in the Japanese Patent Office.

### BACKGROUND OF THE INVENTION

The present invention relates to a photo-finishing apparatus for silver halide photosensitive materials which controls an agitating means to prevent bath exhaustion of the processing solution during its standby time when no processing is conducted, as well as enabling start the processing as soon as a processing order is placed.

Silver halide photosensitive material (hereinafter referred to as a photosensitive material) which is mainly represented by color photography, forms color images via a processing operation which is conducted by an automatic photo-finishing apparatus incorporating processing tanks in which various processing solutions such as developing solution are stored. In recent years, since mini-laboratory systems have become widely used, very common is an in-store processing conducted in general camera shops or photo studios, and thereby when a print processing order is placed, the process is quickly conducted so that the photographic prints as the final products can be provided to a customer in a short time. Due to the convenience, such mini-laboratories have recently been installed at super markets or convenience stores in which photographic processing services were not conducted in the past.

In the photo-finishing apparatus for the photosensitive materials, the temperature of the solutions is so controlled that photographic processing can be started even when no photosensitive material is currently being processed, and thereby, whenever a processing order is placed, the order can be conducted immediately. However, to continuously heat the processing solutions may result in an undesired preservation of quality of the processing solutions. For example, when the amount of the photosensitive materials to be processed is very low, the amount of replenishment during the processing is so low that it is very difficult to maintain the optimal quality of processing solutions. Additionally, in recent years, to reduce the environmental load, there is the trend toward reduction of replenishment rate of the processing solutions, which results in a wrong replacement of the processing solutions via the replenishment of the processing solutions in the processing tanks. Under such conditions, when the solutions are continuously heated, ingredients of the processing solutions are oxidized, resulting is bath exhaustion of the processing solutions, which cannot maintain the expected image formation having desired photo-finishing results. Among the processing solutions, since a color developing agent is directly related to image formation, bath exhaustion of the color developing agent must be so controlled as to not be generated or progress, in order to maintain the desired high quality photo-finishing performance.

Recently however, customers want to visit such shops late at night, increased is the operating hours of the shops in such as supermarkets or convenience stores, accordingly, the operation time of the mini-laboratory system is widely extended. As a result, increased also is the standby time in which the processing solutions are circulated and heated without processing any photosensitive materials, therefore, aerial oxidation of the processing solutions during standby time has become a serious problem. For example, such problems as decrease of color density due to the aerial oxidation of developing agent in the color developing agent, and unclean white background due to increase of staining, have become obvious.

In order to stably operate the photographic photo-finishing apparatus for very small processing orders, the replenishing rate of the processing solutions was increased. However, this method increases the amount of replenishing solutions, as well as the amount of liquid waste, neither of which was preferable from the view point of cost and environment protection. Therefore, in order to prevent bath exhaustion of the processing solutions in the standby condition, technology has been studied in which each temperature of the processing solutions is lowered during non-processing time, and further it is raised to predetermined temperatures in processing time.

For example, a technology shows that a photographic photo-finishing apparatus, including a detecting means to detect the entrance of photosensitive material, a detecting means to detect the temperature of each processing solution, and a control means to control the heating values of heating means, wherein temperature of each processing solution is lowered during the non-processing time, and when the entrance of photosensitive material into the photo-finishing apparatus is detected, the temperature of each processing solution is raised to predetermined temperatures until the photosensitive material arrives at each processing tank (Patent Document 1).

Further another technology is wherein when the photosensitive material is processed, each temperature of each processing solution is set to each optimal temperature, and when no photosensitive material is conveyed, each processing solution is set in acceptable processing temperature lower than optimal temperature, and further when a predetermined interval has passed since the non-processing time started, each processing solution is controlled lower than acceptable processing temperature (Patent Document 2).

According to these technologies, during standby time in which no photosensitive material is processed, since the temperature of each processing solution is set lower than predetermined processing temperatures, it is understood that the progression of processing solution exhaustion due to aerial oxidation is reduced to some degree. However, since digital cameras have become widely used, and photographic development via a wet chemical method has been greatly reduced, in addition, 24-hour operations have increased, whereby, the non-processing time of the photo-finishing apparatus has increased dramatically. Countermeasures to these problems are strongly sought.

[Patent Document 1: JP-A 2001-154326]

[Patent Document 2: JP-A 2003-280157]

### SUMMARY OF THE INVENTION

The present invention is conducted based on the view points described above. An objective of the present invention is to provide a photo-finishing apparatus for silver halide photosensitive material, wherein during standby time in which no photosensitive material is processed, aerial oxidation of the solutions are extremely reduced so that exhaustion of the processing solutions is minimized, and the initial quality of the processing solutions can be prolonged.

Further, an objective of the present invention is to provide a photo-finishing apparatus wherein the photo-finishing apparatus can quickly start the processing operation after a very long standby time, and conduct the processing operation in any case.

Various methods to overcome chemical reactions were used in prior art, wherein in order to prevent bath exhaustion of the processing solutions, the processing solutions were maintained at temperatures lower than the acceptable processing temperatures during standby time. However, though temperatures were set lower, the heater for each processing solution was repeatedly turned on or off to maintain the required temperature, in addition, in order to maintain uniform temperature in each processing tank, respective circulation pumps were activated simultaneously. Due to this, the working time of the circulation pumps become longer, and aerial oxidation of processing solutions would not be effectively controlled.

The present inventor investigated whether the aerial oxidation of the processing solutions is accelerated by agitation or circulation of the processing solutions. That is, the inventor thought out a method for making the down time of agitation and circulation during standby time to be longer wherever possible. To be more precise, the inventor found that after turning off the heater operation, the temperature of the processing solution does not drop rapidly but drops slowly, and further, when the heater is activated at the maximum rate, the temperature of the processing solutions increases at relatively rapid speed, yet further, the inventor found that while the heater was not activated, the circulation pump did not need to be on, but the circulation pump should be activated only when the heater was activated.

The present inventor found that repeating the natural cooling and re-heating reduce the total operating time of the circulation pump more than to continuously keep the processing solution at a low temperature, which resulted in the present invention. That is, the present invention overcomes the above problems by any one of the following structures.

Structure 1

A photo-finishing apparatus for a silver halide photosensitive material, including an agitating means to agitate or circulate a processing solution in a processing tank, a time detecting means to detect the elapsed time since a processing operation was completed, a temperature detecting means to detect the temperature of the processing solutions in the processing tank; and a control means to control operation of the agitating means, wherein when the time detecting means detects the predetermined elapsed time, the control means stops the operation of the agitating means; and wherein when the temperature detecting means detects that the temperature of the processing solutions in the tank has dropped lower than a predetermined lower limit temperature, the control means operates the agitating means, and continues the operation of the agitating means until the temperature detecting means detects that the temperature of the processing solution in the tank has increased to a predetermined acceptable processing temperature.

Structure 2

A photo-finishing apparatus for a silver halide photosensitive material, including an agitating means to agitate or circulate the processing solution in a processing tank, a heating means to heat and re-heat the processing solution in the processing tank, a time detecting means to detect the elapsed time since a processing operation was completed, a temperature detecting means to detect the temperature of the processing solution in the processing tank; and a control means to control operation of the heating means and the agitating means, wherein when the time detecting means detects the predetermined elapsed time, the control means stops the operation of the heating means and the agitating means, and wherein when the temperature detecting means detects that the temperature of the processing solution in the tank has dropped lower than a predetermined lower limit temperature, the control means operates the heating means and the agitating means, and continues the operation of the heating means and the agitating means until the temperature detecting means detects that the temperature of the processing solution in the processing tank has increased to a predetermined acceptable processing temperature.

Structure 3

The photo-finishing apparatus for a silver halide photosensitive material in Structure 1 or 2, wherein the lower limit temperature is more than 1° C. lower than the acceptable processing temperature.

Structure 4

The photo-finishing apparatus for a silver halide photosensitive material in any one of Structures 1-3, wherein at least one of the processing solutions is a developing solution.

Structure 5

The photo-finishing apparatus for a silver halide photosensitive material in any one of Structures 1-4, wherein the control means controls the temperature detecting means to intermittently check the temperature of the processing solution in the processing tank at a predetermined interval, and at least before the temperature detecting means checks the temperature, the control means controls the agitating means to operate for a predetermined time.

Structure 6

The photo-finishing apparatus for a silver halide photosensitive material in any one of Structures 1-5, wherein the lower limit temperature is determined by a processing waiting time in which the temperature increases from the lower limit temperature to the acceptable processing temperature by operation of the agitating means, and wherein the photo-finishing apparatus includes a selecting means which an operator uses to select the processing waiting time.

Structure 7

The photo-finishing apparatus for a silver halide photosensitive material in Structures 1-6, further including a selecting means whereby the operator selects an elapsed time after the end of the processing operation, that is, the elapsed time is the time interval from detection of the completion of the processing operation by the time detecting means, to stoppage of the operation of the agitating means.

Structure 8

A method to control processing solutions for a silver halide photosensitive material, including steps of detecting a predetermined elapsed time after the completion of a processing operation, and stopping agitation of the solution in a tank, starting agitation of the solution when the temperature of the solution is lower than a predetermined lower limit temperature, and keeping agitation of the processing solution until the temperature of the processing solution increases to the predetermined acceptable processing temperature.

Structure 9

A method to control the processing solution for a silver halide photosensitive material, including steps of detecting a predetermined elapsed time after the completion of a processing operation, and stopping the heating and the agitation of the solution in a tank, starting agitation of the solution when the temperature of the solutions is lower than a predetermined lower limit temperature; and keeping agitation of the processing solution until the temperature of the processing solution increases, to the predetermined acceptable processing temperature.

Structure 10

The method to control processing solutions for a silver halide photosensitive material in Structure 8 or 9, including step of the lower limit temperature is lower than the acceptable processing temperature by more than 1° C.

### BRIEF DESCRIPTION OF THE DRAWINGS

FIG. 1 is a drawing showing photo-finishing apparatus 1 incorporating a computer.

FIG. 2 is a schematic sectional drawing showing an example of the photographic processing procedure.

FIG. 3 is a detailed sectional view of processing tank 2 for the developer shown in FIG. 2.

FIG. 4 is a block diagram showing the outline of the control system of photo-finishing apparatus 1 of the present invention.

FIG. 5(a) shows the change of temperature of the color developing agent in processing tank 2 of photo-finishing apparatus 1 of the present invention.

FIG. 5(b) shows the change of temperature of the color developing agent in the processing tank of the conventional photo-finishing apparatus.

FIG. 6 is a flowchart showing the control flow of temperature and circulation under the standby mode.

### DETAILED DESCRIPTION OF THE PREFERED EMBODIMENT

The present invention relates to a photo-finishing apparatus for a silver halide photosensitive material, and a control method for the processing solution for silver halide photosensitive material, and in particular, to a control method of the photo-finishing apparatus. Whereby, even when standby time is very long, progression of bath exhaustion of the processing solution due to aerial oxidation is prevented, in addition, as soon as a processing order for a photosensitive material is placed, the operator can start processing it almost at once.

As a factor of increasing aerial oxidation of the processing solution in the processing tank during standby condition, the inventor focused attention on the influence of agitation or circulation during the standby status. The inventor thought that progression of aerial oxidation of the processing solution during standby time would be controlled by terminating circulation of the agitating means for an extended time during standby. Further, the inventor considered it unacceptable that after the photo-finishing apparatus enters the standby state, the temperature of the processing solution drops too low to resume processing immediately. The inventor further thought that the agitating means should be operated based on the temperature of the processing solution during standby.

After studying above matters, the inventor structured the photo-finishing apparatus described below, in which a standby status is detected, the apparatus detects the temperature of the processing solution during the standby condition, and the apparatus controls at least the operation of the agitating means based on the detected temperature. Therefore, progression of exhaustion of the processing solution during the standby condition is minimized, as well as after an extended standby status, the apparatus can immediately start operation for an urgent photographic processing order.

Details of the invention will be described below.

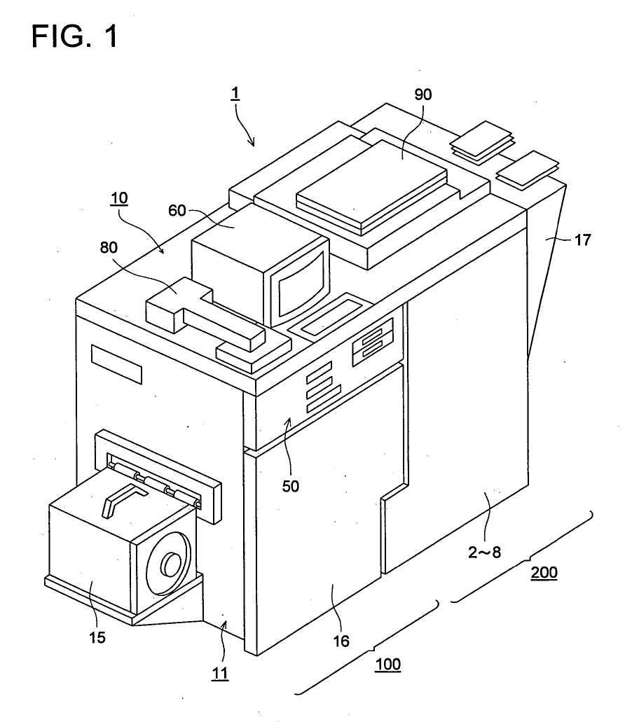

FIG. 1 shows photo-finishing apparatus 1 incorporating a computer, being an embodiment of the photo-finishing apparatus related to the present invention. Said photo-finishing apparatus 1 (in FIG. 1) includes exposure section 100 and processing section 200, and produces color photographic prints from processed color film. Exposure section 100 includes magazine loading section 15 for loading a magazine having photosensitive material therein and also includes exposure unit 16 to expose an image onto a section of photosensitive material. Processing section 200 includes processing tanks 2-6, squeezing section 7, and dryer section 8, by all of which the images, exposed onto photosensitive material based on the above described processing procedure, are processed and dried, to produce photographic prints. Each photographic print is ejected onto tray 17 attached on the right side of main body 11.

Photo-finishing apparatus 1 has computer 10, which includes control section 50 to control operations of each section of photo-finishing apparatus 1, display section 60 such as a CRT, memory section 51, which is not illustrated, stores information of the processing history of photo-finishing apparatus 1, and a communication section which communicates with peripheral devices via a network. Control section 50 also controls the heating section and the agitating section related to the present invention. Further, when photo-finishing apparatus 1 is in a standby status, control section 50 controls activation and deactivation of the heating means and the agitating means.

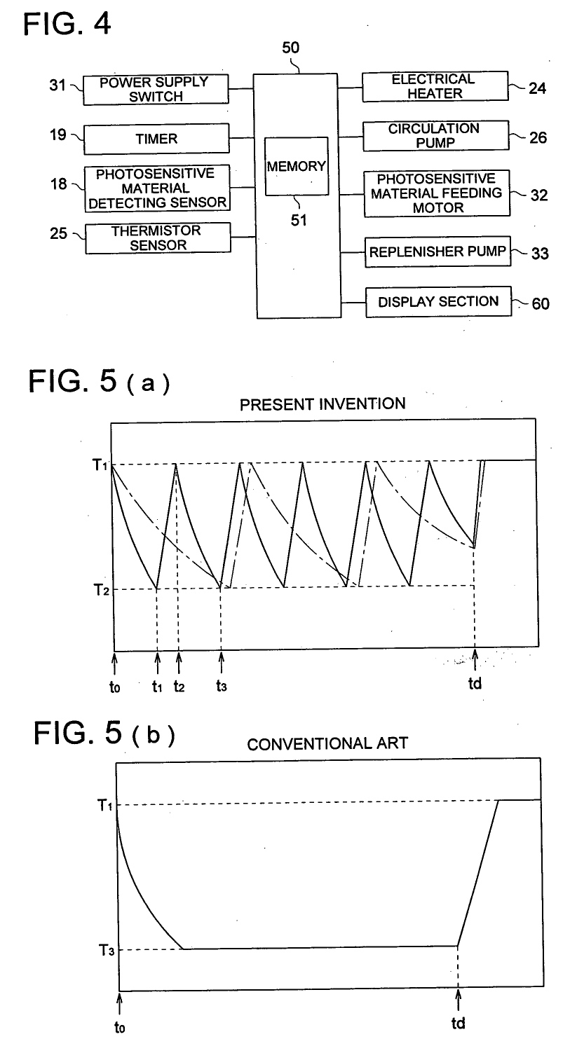

As shown in FIG. 4, control section 50 is connected to detecting member 18, being a time detecting means of the present invention, which detects whether photosensitive material stored in the magazine has supplied to the processing sections. Detecting member 18 includes a sensor and a timer. Otherwise the functions of first detecting section can also be conducted by control section 50.

Next, to be detailed is an example of the photographic processing procedures performed by the photo-finishing apparatus related to the present invention.

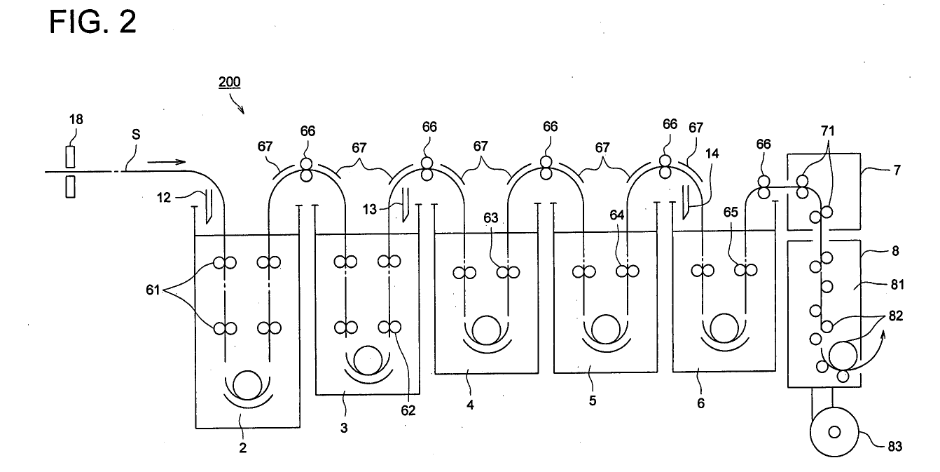

FIG. 2 is a schematic sectional drawing showing an example of the photographic processing procedure, which is conducted to process photosensitive color paper, in processing section 200 of photo-finishing apparatus 1 shown in FIG. 1. Photographic processing of color paper is described as an example, but the photo-finishing apparatus related to the present invention is not limited thereto. The control method of the photographic processing solution related to the present invention can also be used for silver halide photosensitive materials, such as color negative film, color reversal film, direct positive paper, X-ray film, graphic film, monochromatic negative film, and monochromatic paper. The photo-finishing apparatus for the silver halide photosensitive material related to the present invention can be used for photographic processors, such as a color negative film processor, a color reversal film processor, a monochromatic negative film processor, a monochromatic reversal film processor, a color paper processor, a monochromatic paper processor, an X-ray film processor, a graphic film processor and a printer-processor (Printer-processor includes an exposure section and a color paper processing section).

In FIG. 2, the photographic processing procedure is conducted to process color paper in paper processor section 200 having a roller transport method. Paper processor section 200 of photo-finishing apparatus 1 includes processing tank 2 to store color developing agent, processing tank 3 to store bleach-fixer, and processing tanks 4-6 to store image stabilizers.

A plurality of paired transport rollers 61 are arranged in processing tank 2 to convey color paper S in a predetermined route. A plurality of paired transport rollers 62, and 63-65 are arranged in processing tank 3 and processing tanks 4-6, respectively.

Paired crossover rollers 66 are installed between each processing tank. Paired crossover rollers 66 nip color paper and squeeze the solution from the surface of the color paper, preventing solution from entering the following processing tank.

Guides 67 are installed on both sides of each pair of crossover rollers 66 to guide color paper from one processing tank to the next.

In addition, paired transport rollers 61-65 and guides 67 are assembled in a processing rack, and an assembled processing rack is installed in each processing tank.

As shown in FIG. 2, color paper S, being a photosensitive material, passes paper detecting sensor 18 (serving as a time detecting means). Paper detecting sensor 18 detects both the leading and the trailing edge of color paper. Detected information data from sensor 18 is sent to control section 50 as electrical signals.

Color paper S passed on paper detecting sensor 18 is conveyed by rollers 61-65 through processing tanks 2-6, whereby color paper enters each processing solution so that color developing, bleach-fixing, and stabilizing processes are conducted on color paper S.

Squeezing section 7 is installed downstream of processing tank 6, as shown in FIG. 2. A plurality of paired squeezing rollers 71 are arranged along the conveyance route of color paper S, which nip and transport color paper which has been stabilized, whereby moisture in processed color paper is removed.

Dryer 8, installed below squeezing section 7, includes casing 81, and hot air supplying means 83 in casing 81. Conveyance rollers 82 within casing 81 are arranged along the conveyance route of color paper S.

Hot air supplying means 83 includes a fan and a heater, to supply hot air, being 35-100° C. or more preferably 40-80° C. into casing 81 via an air duct. Color paper S, having passed through squeezing section 7, is conveyed by conveyance rollers 82 in casing 81 and dried via hot air. By passing through the above procedures, color paper is processed in processing section 200 of photo-finishing apparatus 1 being the photo-finishing apparatus related to the present invention.

The processing solution in every processing tank 2-6 of processing section 200 is replenished respectively. Any overflow solution is ejected from each processing tank to the exterior of the apparatus as waste liquid.

Replenisher is supplied to each processing tank. Developing replenisher is supplied to processing tank 2 via replenisher tube 12, while bleach-fixing reprenisher is supplied to processing tank 3 via replenisher tube 13, and stabilizing replenisher is supplied to processing tanks 4-6 via replenisher tube 14. Various replenishing methods are possible. For example, replenisher in an accomplished condition is supplied to the processing tank, or concentrated liquid or concentrated liquid kits including various liquids are supplied to the processing tank with diluent water, as well as, solid state replenisher is supplied to the processing tank with diluent water.

When diluent water is used, a water stock tank, which is not illustrated, is provided in photo-finishing apparatus 1.

In each processing tank 2-4, a drainage outlet, not illustrated, is assembled respectively. As each replenisher is supplied to processing tanks 2 and 3 via replenisher pipes 12 and 13, the deteriorated developer and bleach-fixer at nearly the same amount of each replenisher are drained via the drainage outlets. As the replenisher is supplied to processing tank 6 via replenisher pipe 14, the stabilizer in processing tank 6 overflows into processing tank 5, and further, stabilizer overflows from processing tank 5 to processing tank 4, and finally, stabilizer overflows from processing tank 4 to the outside via a drainage outlet.

The color developing agent in processing tank 2 is preferably heated to a predetermined temperature by the heating means, which is not illustrated. The bleach-fixer and the stabilizer are also preferably heated to each predetermined temperature by heaters, which are again not illustrated.

Transferred temperature control used in the photo-finishing apparatus related to the present invention will be detailed below. In the present invention, it is possible that a heater is provided only for processing tank 2 which is for the color developing agent, and plumbing from processing tank 2 is piped through the other processing tanks so that heat of the color developing agent passing through the plumbing formed in the other tanks is transferred to the processing solutions in the other processing tanks, and thereby the temperature of the other processing solutions follows the temperature of the color developing agent. By employing a transferred temperature control in which the temperature of the color developing agent is transferred, the quantity of heaters for temperature control is reduced, resulting in cost reduction of the processing section. Though only one heat source is in the processing section, the color developing agent is heated and naturally cooled to be between the acceptable processing temperature and the lower limit temperature. Due to this, both the temperatures of bleach-fixer in processing tank 3 and the temperature of the stabilizer in processing tank 4 can be maintained on some set level. Accordingly, when a print processing order is placed after long standby status, the temperatures of the bleach-fixer and the stabilizer are not so low that the processing can be started without waiting for a relatively long heating time.

The agitating means and the heating means used in the photo-finishing apparatus related to the present invention will be detailed below.

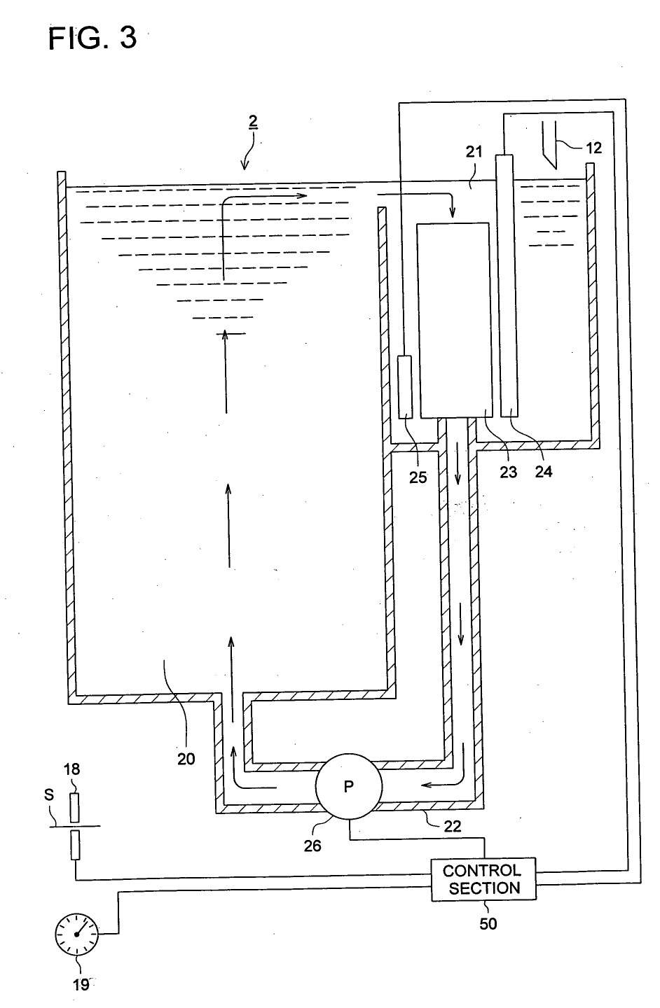

FIG. 3 is a detailed sectional view of processing tank 2 for the developer shown in FIG. 2. In not only processing tank 2 but also in processing tanks 3 and 4, various sections described below are also incorporated. In FIG. 3, processing tank 2 for the color developing agent features main tank 20 for developing color paper, on which a photographic image has been already exposed, auxiliary tank 21 for adding the replenisher of the color developing agent or filtering the color developing agent, and circulation piping 22 to connect main tank 20 and auxiliary tank 21. Replenisher pipe 12 is provided above auxiliary tank 21, whereby the sufficient replenisher of the color developing agent, based on the processed amount of color paper, is supplied.

Auxiliary tank 21 includes electrical heater 24 as the heating means for the color developing agent, filter 23 to filter foreign particles carried into the tank by the color paper, and thermistor sensor 25, being the temperature detecting means of the present invention, which monitors the temperature of the color developing agent in the tank.

Circulation pump 26, being the agitating means of the present invention, is provided in circulation pipe 22 between main tank 20 and auxiliary tank 21, whereby agitation and circulation of the color developing agent can be conducted. Since the color developing agent circulates between main tank 20 and auxiliary tank 22 via circulation pipe 22, the temperature as well as the density concentration of the included components in the color developing agent are uniformly maintained, and thereby, processing performance over the predetermined level is maintained in the developing procedure.

The circulating direction of the color developing agent is shown by the arrows in FIG. 3, however, the opposite direction is also possible for the circulation.

In the present invention, since natural cooling time is relatively long under standby status, and the acceptable processing temperature can be quickly attained via heating, operation time of the agitating means is set to the lowest level so that ambient aerial oxidation of the processing solution is minimized. In the photo-finishing apparatus related to the present invention, the capacity of the main tank is 2-30 liters, and the surface ratio (ratio of the open area of the liquid surface and the volume of the tank) is preferably less than 30 cm²/liter. Within this value limit, a desired effect of the invention is effectively demonstrated, that is, the ambient aerial oxidation of the color developing agent during standby time is effectively restricted.

Further, in order to reduce the ambient aerial oxidation of the color developing agent, a large number of small balls can be floated on the exposed surface of the liquid in auxiliary tank 21, which can also demonstrate the desired effect of the present invention.

In addition, to keep the color developing agent warm, heat insulating materials can be adhered on the exterior surfaces of the main tank and the auxiliary tank, or the main tank and the auxiliary tank can be formed of materials having high insulation efficiency. Accordingly, once the color developing agent is heated, it can be protected from radiating heat.

Photo-finishing apparatus 1 includes control section 50 which controls the operations of circulation pump 26 and electrical heater 24, based on the signals from each detecting section. FIG. 4 shows the outline of the control system of photo-finishing apparatus 1 relating to the present invention. Various detecting means detect the condition of the various members in photo-finishing apparatus 1, such as main power switch 31 and timer 19, and send signals to control section 50, which checks the received signals by comparing with information previously stored in memory section 51, and controls various members, based on the checked results, such as electrical heater 24 and circulation pump 26, in photo-finishing apparatus 1. In FIG. 4, numerals 18, 19, 25, and 31 represent the means which send signals to control section 50, while numerals 24, 26, 32, 33, and 60 represent the means which are controlled by control section 50.

Detailed below, as an example, is the control conducted by control section 50, from when the operator turns on main power switch 31 to when printer processor reaches the acceptable processing condition. That is, after main power switch 31 is turned on, a power-on signal is sent to control section 50, which checks temperature information of the color developing agent in processing tank 2 by monitoring thermistor sensor 25, and operates circulation pump 26 and electrical heater 24 to heat the color developing agent to the predetermined temperature. In addition, control section 50 displays appropriate messages on display 60, such as “now heating, please wait”.

When the temperature detected by thermistor sensor 25 reaches the predetermined temperature, control section 50 changes the operation of electrical heater 24 from high to low heating. Further, control section 50 displays the messages of “operational temperature” on display 60.

As mentioned above, control section 50 controls the operation of each section in photo-finishing apparatus 1 relating to the present invention. Yet further, memory section 51 in control section 50 stores various information. For example, stored are various programs to make photo-finishing apparatus 1 to perform the predetermined operation, for example, the flow rate and the flow volume of circulation pump 26, the heating condition of electrical heater 24, and the color paper conveyance speed of driving motor 32, based on the predetermined conditions set in the programs, and various information of the operating history of photo-finishing apparatus 1, such as the processed amount of color paper during a predetermined interval, history of changing liquid filter 23, as well as amount and kinds of replenisher and color paper.

Next, referring to FIG. 3, described below are the control methods for the agitating means and the heating means, when the photo-finishing apparatus has entered standby status. FIG. 3 shows the sectional view of processing section 200 including main tank 20, auxiliary tank 21, circulation piping 22, as well as the control system simplified than that of FIG. 4.

In the present invention, control section 50 of photo-finishing apparatus 1 detects that apparatus 1 has not processed color paper for a predetermined time, and thereby recognizes that apparatus 1 is under standby status. Further, in order not to deteriorate the color developing agent stored in processing tank 2, control section 50 deactivates circulation pump 26 which is the circulation means (hereinafter this condition is also described “standby mode”). Firstly, in order to check whether color paper S has been supplied to photo-finishing apparatus 1, control section 50 checks whether a predetermined time has passed, since the last photographic processing was completed in photo-finishing apparatus 1, by using signals from color paper detecting sensor 18, or signals from timer 19 which works based on signals from color paper detecting sensor 18. After which, based on the checked result that the predetermined time has elapsed, control section 50 determines that photo-finishing apparatus 1 is in standby mode.

As described above, by detecting the passage of the predetermined time after the last processing, control section 50 signals photo-finishing apparatus 1 to enter standby mode. In the present invention, a standard amount of time is previously set to determine the shift to standby mode, and the standard amount of time is memorized in memory 51. Comparing the elapsed time obtained by timer 19 with the standard amount of time in memory 51, control section 50 shifts to standby mode. It is preferable that a selecting means is provided in photo-finishing apparatus 1 so that the operator can optionally select the elapsed time until the shift of standby mode.

After determining that photo-finishing apparatus 1 is in standby mode, control section 50 stops operation of circulation pump 26, in which case, it is preferable that electrical heater 24 is also deactivated by control section 50, however, it is not always necessary that operation of heater 24 is synchronized with that of circulation pump 26. To decrease the temperature of the color developing agent, operation and non-operation of heater 24 will be repeated, due to this, agitation by circulation pump 26 and heating by heater 24 are stopped in processing tank 2. Therefore, progression of ambient aerial oxidation of the color developing agent stored in processing tank 2 is restricted, and quality performance of the color developing agent is maintained.

Next, after control section 50 detects that the temperature of the color developing agent in the processing tank 2 has dropped lower than the predetermined temperature due to the stoppage of circulation pump 26 and electrical heater 24, control section 50 re-activates circulation pump 26, until the temperature of the color developing agent again reaches the acceptable processing temperature. Concerning the means to increase the temperature of the color developing agent to the acceptable processing temperature, heat generated from circulation pump 26 itself, or heat transferred from another tank can be used, but more preferable is that electrical heater 24 is activated simultaneously with circulation pump 26. Since the temperature is returned to the acceptable processing temperature as far as possible, the operating time of circulation pump 26 is shortened so that the deterioration of the color developing agent can be effectively restricted.

To be more precise, to detect the temperature of the color developing agent stored in processing tank 2, control section 50 receives signals from thermistor sensor 25 installed in auxiliary tank 21, and checks whether the temperature has dropped lower than the predetermined temperature (which is the lower limit temperature). In this case, thermistor sensor 25 can be controlled to detect the temperature of the color developing agent continuously, or detect it intermittently at a predetermined interval, but it is important that circulation pump 26 is activated for a predetermined time before themistor sensor 25 is controlled to detect the temperature. If thermistor sensor 25 is controlled to detect the temperature while circulation pump 26 is deactivated, the temperature of the color developing agent in main tank 20 and auxiliary tank 21 is uneven and cannot be measured correctly. On the other hand, if thermistor sensor 25 is controlled to detect the temperature while circulation pump 26 is activated, ambient aerial oxidation of the color developing agent is not completely restricted. Therefore, control section controls thermistor sensor 25 to detect the temperature every ten minutes for example, and circulation pump 26 to be activated for ten seconds, just before thermistor sensor 25 detects the temperature, and thereby, it is possible to precisely detect the temperature and also restrict ambient aerial oxidation of the color developing agent.

By the method described above, using signals from thermistor sensor 25, control section 50 senses that the temperature of the color developing agent in processing tank 2 is less than the predetermined temperature (which is the lower limit temperature), and senses that the temperature must be increased to the acceptable processing temperature.

Control section 50 continuously activates circulation pump 26 and electrical heater 24 to heat the color developing agent stored in processing tank 2 until the temperature of the color developing agent reaches the acceptable processing temperature. During the heating, control section 50 always checks the temperature of the color developing agent by the signals from themistor sensor 25, to determine whether the temperature has reached the acceptable processing temperature. When control section 50 senses that the temperature is at the acceptable processing temperature, control section 50 stops the operations of circulation pump 26 and electrical heater 24.

Further, after circulation pump 26 and electrical heater 24 are deactivated, using the signals from thermistor sensor 25, control section 50 detects whether the temperature of the color developing agent in processing tank 2 has decreased to less than the predetermined temperature (which is the lower limit temperature), and if it is detected to be lower than the predetermined temperature, control section 50 re-activates circulation pump 26 and electrical heater 24 to increase the temperature of the color developing agent to the acceptable processing temperature. During standby mode, control section 50 repeats this action.

When the print order from processed film is placed by the customer under the above-described condition, processing operation is started by the operator, after which control section 50 re-activates circulation pump 26 and electrical heater 24 to increase immediately the temperature of the color developing agent to the acceptable processing temperature. Otherwise when color paper detecting sensor 18 detects color paper, a signal to request the processing operation is automatically sent to control section 50. Further, it is preferable to memorize necessary time data to increase the temperature of the color developing agent from the temperature at each time when the signal to request the processing operation is sent, to the acceptable processing temperature. It is thereby possible to display the necessary time interval from the present time to the arrival time at the acceptable processing temperature, on display 60 via a count-down method.

Control section 50 determines that the temperature of the color developing agent in processing tank 2 has dropped below the predetermined temperature and increases it to the acceptable processing temperature, based on the detected results of thermistor sensor 25, and thereby controls the operation of circulation pump 26 and electrical heater 24. In the present invention, previously set is the temperature (which is the lower limit temperature) of the color developing agent wherein circulation pump 26 and electrical heater 24 are to be re-energized in the standby mode, and said temperature is memorized in the memory means. For example, a program can be previously stored in memory 51 wherein when thermistor sensor 25 detects that the temperature has been reduced to less than 35° C., control section 50 activates circulation pump 26 and electrical heater 24.

Concerning the lower limit temperature, heating times, which are time intervals necessary for increasing the temperature from the lower limit temperature to the acceptable processing temperature by electrical heater 24 and circulation pump 26, are previously measured and stored in memory 51, therefore, the operator can choose any one of the heating times (standby time for waiting for arrival at the acceptable processing temperature). That is, since the operator chooses the maximum waiting time from the standby mode to the arrival of the acceptable processing time, the lower limit temperature of the standby mode is automatically established, and thereby when the customer places the order, the operator can easily calculate the time for completing the received order.

In addition, the circulation pump is used as a circulation means which is employable in the photo-finishing apparatus relating to the present invention. However, a circulation means using bubbled inert gas, such as nitrogen gas typically used for a hanger transporting film processor, as well as other circulation means, such as high pressure spray, and blown air can be included in the present invention.

As just described, in the photo-finishing apparatus related to the present invention, when control section 50 senses the standby mode, it activates or deactivates pump 26 and preferably electrical heater 24 as necessary, so that the deterioration of the color developing agent is restricted. This operation is detailed below, referring to FIG. 5 which shows the change of temperature of the processing solution in the processing tank.

FIG. 5(a) shows the change of temperature of the color developing agent in processing tank 2 of photo-finishing apparatus 1, wherein the ordinate axis represents the change of temperature, in which temperature T₁ represents the acceptable processing temperature of the color developing agent, while temperature T₂ represents the lower limit temperature of the color developing agent under the standby mode. Further, the horizontal axis represents the passage of time from when the photo-finishing apparatus enters the standby mode to when a photographic processing order is placed. Time t₀ represents the time when control section 50 determines shifting to the standby mode, and electrical heater 24 and circulation pump 26 are deactivated. Times t₁ and t₃ represent the time when the temperature of the color developing agent has reached the lower limit temperature, and electrical heater 24 and circulation pump 26 are re-activated. Time t₂ represents the time when the temperature of the color developing agent has reached the acceptable processing temperature, and electrical heater 24 and circulation pump 26 are deactivated. Time t_{d} represents the time when the processing order is placed.

In photo-finishing apparatus 1 relating to the present invention, since control section 50 activates circulation pump 26 and electrical heater 24 when the temperature of the color developing agent has dropped lower than the lower limit temperature in the standby mode, the temperature changes of the color developing agent appear as saw-teeth as shown in FIG. 5(a). Additionally, dashed lines in FIG. 5(a) represent the case wherein processing tank 2 is structured to be a heat-retaining tank by heat retaining materials, such as foamed material. In such case, it is possible to prolong the time interval from activation to deactivation of circulation pump 26 and electrical heater 24, therefore, ambient aerial oxidation of the color developing agent can be effectively restricted, as well as, electrical power consumption under the standby mode can also be reduced.

On the other hand, FIG. 5(b) shows the change of temperature of the color developing agent in the processing tank of the conventional photo-finishing apparatus, wherein activation and deactivation of circulation pump 26 and electrical heater 24 are repeated extensively in the standby mode, to maintain standby color developing agent temperature T₃ which is previously set. In the case of FIG. 5(b), to reduce temperature difference between the main tank and the auxiliary tank, the operation time of circulation pump 26 is rather long, which cannot effectively restrict ambient aerial oxidation of the processing solution. In addition, in the case of FIG. 5(b), when a new processing order is placed by a customer, the apparatus must always increase the temperature from standby color developing agent temperature T₃ to acceptable processing temperature T₁, which takes a rather long time. Accordingly, a major problem is the time interval to increase the solution temperature to the acceptable processing temperature after the processing order has been placed, therefore, it is almost impossible to offer quick processing service.

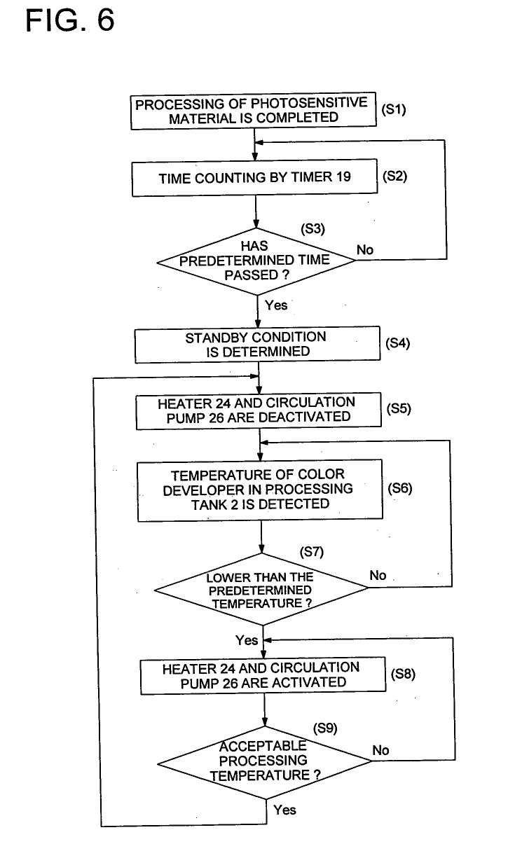

Next, referring to the flowchart of FIG. 6, detailed is how control section 50 detects the standby condition in photo-finishing apparatus 1, and also shows the control flow of temperature and circulation under the standby mode. The flowchart in FIG. 6 assumes that photo-finishing apparatus 1 has previously been under acceptable processing conditions.

Firstly, after a predetermined time has elapsed, since paper detecting sensor 18 detects the trailing edge of the photosensitive material (which is color print paper), and if paper detecting sensor 18 has not detected the leading edge of the new photosensitive material during said predetermined time, control section 50 determines that photographic processing is completed in photo-finishing apparatus 1 (Step S1). Then timer 19 starts counting (Step S2).

Next, control section 50 determines whether the predetermined time has passed after timer 19 starts counting (Step S3). If the predetermined time has passed (Yes in Step S3), control section 50 switches to the standby mode (Step S4). Control section 50 then deactivates circulation pump 26 as the agitation means and electrical heater 24 as the heating means (Step S5). That is, in the present invention, when control section 50 determines that photo-finishing apparatus is under the standby mode, not only the agitating means but also the heating means are terminated, and thereby, deterioration of the color developing agent is effectively minimized.

After circulation pump 26 and electrical heater 24 are deactivated, control section 50 continues to monitor the temperature of the color developing agent in processing tank 2 via thermistor sensor 25 (Step S6), and thereby, control section 50 controls the operation of circulation pump 26 and electrical heater 24, based on the detected temperature. When control section senses that the temperature of the color developing agent is higher than the lower limit temperature (No in Step S7), circulation pump 26 and electrical heater 24 continue to be deactivated, while when the temperature is lower than the lower limit temperature (Yes in Step S7), control section 50 re-activates circulation pump 26 and electrical heater 24 to heat the color developing agent in processing tank 2 to the acceptable processing temperature (Step S8). When control section senses that the temperature of the color developing agent in processing tank 2 detected by thermistor sensor 25 has returned to the predetermined temperature (Yes in Step S9), control section 50 deactivates circulation pump 26 and electrical heater 24 (Step S5). However, when control section 50 determines that the temperature has not returned to the predetermined temperature (No in Step S9), control section 50 continues activation of circulation pump 26 and electrical heater 24. Further, while photo-finishing apparatus 1 is in the standby mode, control section 50 repeats the operation from steps S5 to S9.

In addition, whenever a processing order is placed in every step in FIG. 6, control section terminates the standby mode immediately, and re-activates circulation pump 26 and electrical heater 24 to increase the temperature to the predetermined acceptable processing temperature, whereby, control section 50 maintains the temperature of the color developing agent in processing tank 2.

Via the above procedure, in the present invention, while control section determines that photo-finishing apparatus 1 is in the standby mode, that is, apparatus 1 is not performing the processing operation, control section 50 deactivates circulation pump 26 and electrical heater 24, and the change of temperature appears like saw-teeth in FIG. 5(a). Accordingly, any negative effects generated by agitation and heating are reduced so that deterioration of the processing solution due to ambient aerial oxidation can be minimized.

### EXAMPLE

The targeted effects of the present invention are made apparent by the experiment described below.

Experimental Condition

Photo-finishing apparatus: color negative film processor CL-KP46QA, produced of Konica Minolta Co., in which the control means relating to the present invention was installed. A heater was installed only into the processing tank for the color developing agent, and the plumbing from processing tank 2 was routed through the other processing tanks so that heat from the color developing agent passing through the plumbing formed in the other tanks was radiated to the processing solutions in the other processing tanks, and thereby the temperature of the other processing solutions follows the temperature of the color developing agent. The volume of the processing tank for the color developing agent is 16.4 liter, the opening surface area ratio is 15 cm²/liter and CL-LP 46QA was operated under room temperature of 20° C.

The processing solutions made of Konica Minolta Co.,

Color developing agent: CNK-4-52N1R and CNK-4-52N1S

Bleaching agent: CNK-4-52N2R and CNK-4-52N2S

Fixing agent: CNK-4-52N3R

Stabilizing agent: CNK-4-52N4R.

### Experiment 1 (Comparative Example 1)

Temperature of the color developing agent was set to 38° C., which is normal developing temperature. Temperature control was conducted for 14 hours during day time, but no film was processed. The circulation pump was always activated, and the heater was controlled to maintain the set temperature (38° C.). During the night (10 hours), the circulation pump and the heater were deactivated. This procedure was repeated for 10 days, after which the density of the color developing agent was measured. The ambient aerial oxidation constant was calculated to be 0.00854 day⁻¹, while ambient aerial oxidation constant k is calculated via the following formula.
k=(ln C₀−ln C₁₀)/10

k: aerial oxidation constant,

ln: naturalized logarithm,
C₀: density (gram/liter) of color developing agent in initial condition,
C₁₀: density (gram/liter) of color developing agent after 10 days.

### Experiment 2 (Comparative Example 2)

Firstly, the temperature of the color developing agent was increased to 38° C. (the processing temperature), and then set to 34° C. (the standby temperature). The temperature control was conducted for 14 day-time hours, but no film was processed. The circulation pump was always activated, and the heater was controlled to maintain the set temperature (34° C.). During 10 night hours, the circulation pump and the heater were deactivated. This procedure was repeated for 10 days, after which the density of the color developing agent was measured. Ambient aerial oxidation constant was calculated to be 0.00623 day⁻¹. Compared to the result of experiment 1, ambient aerial oxidation rate was reduced, resulting in 73% that of experiment 1.

In addition, it took 15 minutes to increase the temperature from the 34° C. standby temperature to the 38° C. processing temperature. That is, in experiment 2, it always took 15 minutes to return from the standby mode to the start of functional processing.

### Experiment 3 (the Present Invention)

After the temperature of the color developing agent was increased to 38° C. (being the processing temperature), the circulation pump and the heater were immediately deactivated, and the color developing agent was allowed to cool naturally, during which the following operation were performed.

Firstly, the circulation pump was activated every 5 minutes for 10 sec, and after the temperature was measured, the circulation pump was deactivated. Next, when the temperature of the color developing agent reached 34° C., the circulation pump and the heater were activated, and continued to be activated, until the temperature reached 38° C. When the temperature of the color developing agent reached 38° C., the circulation pump and the heater were deactivated.

This procedure was repeated for a 14-hour day, but no film was processed, and for 10 night time hours, the circulation pump and the heater were deactivated. This cycling was repeated for 10 days, the density of the color developing agent was measured, and the ambient aerial oxidation constant per a day was calculated, resulting in 0.00504 day⁻¹. Compared to the result of experiment 1, the ambient aerial oxidation rate was reduced, resulting in 59% that of experiment 1.

In addition, it took 90 minutes for the color developing agent to cool naturally from 38° C. to 34° C., and it took only 15 minutes to return the color developing agent from 34° C. to 38° C. That is, the longest waiting time from the standby mode to the start of processing was 15 minutes in experiment 3, while during the natural cooling time, it was less than 15 minutes for the recovery of the temperature, and thereby the average waiting time was shortened. For example, it took about 5 minutes to recover from 37° C. in the natural cooling time to 38° C. as the processing temperature.

As mentioned above, deterioration of the processing solution due to ambient aerial oxidation was minimized in the present example. Even when the standby time was very long, the processing operation could be started within the short time so that the targeted effect of the present invention was exhibited.

In the present invention, as the reason of the aerial oxidation, the inventor focused attention to the agitation and the circulation of the processing solution during the standby mode. The inventor controlled the operation of the agitating means during the standby mode so that the progression of the ambient aerial oxidation of the processing solution during the standby time was minimized. Further, after the photo-finishing apparatus enters the standby mode, in order not to reduce the temperature of the processing solution too much, the heating means and the circulation means were activated based on the temperature of the processing solutions, and thereby, the processing service was quickly re-started after the standby mode.

As a result, even when the standby time is very long, the performance of the processing solution in the processing tank was not deteriorated during the standby time, as well as the rapid processing service which did not require the customer to wait, being the objective of the mini-laboratory system, was established by the photo-finishing apparatus of the present invention.

The effects of the invention will be detailed below. According to the invention described in Structure 1 or 8, agitation of the processing solution is stopped when the predetermined elapsed time has passed since the photographic process was completed. After that, agitation re-starts when the temperature of the processing solution drops below the predetermined temperature, and continues until the temperature of the processing solution rises to the acceptable processing temperature.

Further, according to the inventions in Structure 2 or 9, heating and agitation of the solution is stopped when the predetermined elapsed time has passed since the photographic process was completed. After that, heating and agitation re-start when the temperature of the processing solution drops below the predetermined temperature, and heating and agitation continue until the temperature of the processing solution rises to the acceptable processing temperature.

Still further, the invention in Structure 3 or 10 teaches that agitation should be re-started after detecting how much the temperature of the processing solution has decreased below the acceptable processing temperature.

Accordingly, by the present invention, during business hours, in which the photo-finishing apparatus is in a standby time, at least the agitating means is controlled not to operate so that the processing solution is not circulated needlessly, and thereby bath exhaustion of the processing solution is minimized, and the desired high quality photo-finishing performance can be maintained.

Still further, during a standby time, since the temperature of the processing solution is between the predetermined lower limit temperature and the acceptable processing temperature, even when the photo-finishing apparatus is in a standby condition for a long time and an urgent processing order is placed, the photo-finishing apparatus can be re-started within a short time. Accordingly, processing service can quickly and always be provided to the customer, that is, the mini-laboratory system can perform its original performance most satisfactorily.

Still further, in a standby time, the agitating means is operated at a minimum requirement, whereby electrical power consumption and running cost of the photo-finishing apparatus can be reduced, as well as providing an ecological and sustainable photo-finishing apparatus.

According to the invention described in Structure 4, though the developing solution is very sensitive to aerial oxidation, its development performance can stably be maintained, and thereby decrease of color density due to aerial oxidation of developing agent in the color developing agent, and off-white background due to increase of staining can be reduced.

According to the invention described in Structure 5, while the agitating means is stopped and the processing solution is in a natural cooling down condition, the temperature of the processing solution can be accurately detected, and thereby detection error due to uneven temperature in the processing tank is prevented, in addition, the agitating means is controlled to work only as needed, resulting in the reduced aerial oxidation of the processing solution.

According to the invention described in Structure 6, a maximum waiting time between standby time and a reaching time of acceptable processing temperature can be set as appropriate. The working condition can be determined based on processing duration time and amount.

According to the invention described in Structure 7, since the elapsed time between the end of the processing operation and start of standby time can be determined as appropriate by the operator, the apparatus cannot enter the standby mode directly.

What is claimed is:

1. A photo-finishing apparatus for a silver halide photosensitive material, comprising:
an agitating device to agitate or circulate a processing solution in a processing tank;
a time detecting device to detect an elapsed time since a processing operation was completed;
a temperature detecting device to detect temperature of the processing solution in the processing tank; and
a control section to control operation of the agitating device by such ways that when the time detecting device detects a predetermined elapsed time, the control section deactivates the agitating device, and when the temperature detecting device detects that the temperature of the processing solution in the processing tank has dropped lower than a predetermined lower limit temperature, the control section re-activates the agitating device, and continues to activate until the temperature detecting device detects that the temperature of the processing solution in the processing tank has increased to a predetermined acceptable processing temperature.

2. A photo-finishing apparatus for a silver halide photosensitive material, comprising:
an agitating device to agitate or circulate a processing solution in a processing tank;
a heating device to heat the processing solution in the processing tank;
a time detecting device to detect an elapsed time since a processing operation was completed;
a temperature detecting device to detect the temperature of the processing solution in the processing tank; and
a control section to control operation of the heating device and the agitating device by such ways that when the time detecting device detects the predetermined elapsed time, the control section deactivates the heating device and the agitating device, and when the temperature detecting device detects that the temperature of the processing solution in the processing tank has dropped lower than a predetermined lower limit temperature, the control section re-activates the heating device and the agitating device, and continues to activates the heating device and the agitating device until the temperature detecting device detects that the temperature of the processing solution in the processing tank has increased to a predetermined acceptable processing temperature.

3. The photo-finishing apparatus for a silver halide photosensitive material in claim 1, wherein the lower limit temperature is more than 1° C. lower than the acceptable processing temperature.

4. The photo-finishing apparatus for a silver halide photosensitive material in claim 1, wherein at least one of the processing solutions is a color developing solution.

5. The photo-finishing apparatus for a silver halide photosensitive material in claim 1, wherein the control section controls the temperature detecting device to intermittently check the temperature of the processing solution in the processing tank at a predetermined interval, and at least before the temperature detecting device checks the temperature, the control section activates the agitating device for a predetermined time.

6. The photo-finishing apparatus for a silver halide photosensitive material in claim 1, wherein the lower limit temperature is determined by a processing waiting time in which the temperature increases from the lower limit temperature to the acceptable processing temperature by operation of the agitating device, and wherein the photo-finishing apparatus further includes a processing waiting time selecting device which an operator uses to select the processing waiting time.

7. The photo-finishing apparatus for a silver halide photosensitive material in claim 1, further includes an elapsed time selecting section which the operator uses to select an elapsed time which is a time interval from when the time detecting device detects the completion of the processing operation to when the agitating device is deactivated.

8. A method to control processing solution for a silver halide photosensitive material, comprising steps of:
detecting a predetermined elapsed time after a processing operation was completed, and stopping agitation of a processing solution in a processing tank;
starting agitation of the processing solution when the temperature of the solution is lower than a predetermined lower limit temperature; and
keeping agitation of the processing solution until the temperature of the processing solution increases to a predetermined acceptable processing temperature.

9. A method to control the processing solution for a silver halide photosensitive material, comprising steps of:
detecting a predetermined elapsed time since the processing operation was completed, and stopping the heating and the agitation of a processing solution in a processing tank;
starting agitation of the processing solution when the temperature of the solutions is lower than a predetermined lower limit temperature; and
keeping agitation of the processing solution until the temperature of the processing solution increases to a predetermined acceptable processing temperature.

10. The method to control the processing solution for a silver halide photosensitive material in claim 8, wherein the lower limit temperature is lower than the acceptable processing temperature by more than 1 degree.
